(19) United States
(12) Patent Application Publication
(10) Pub. No.: US 2023/0243315 A1
(43) Pub. Date: Aug. 3, 2023

(54) METHOD TO MITIGATE REVERSE OIL FLOW TO THE COMBUSTION CHAMBER VIA HYBRID CYLINDER CUTOUT FOR INTERNAL COMBUSTION ENGINES

(71) Applicants: Michael J. Holihan, Woodstock, GA (US); Patrick J. Derbin, Milford, MI (US)

(72) Inventors: Michael J. Holihan, Woodstock, GA (US); Patrick J. Derbin, Milford, MI (US)

(21) Appl. No.: 18/186,144

(22) Filed: Mar. 17, 2023

(51) Int. Cl. F01M 1/16; F02D 41/00

(52) U.S. Cl. CPC F01M 1/16; F02D 41/0087

(57) ABSTRACT

This disclosure generally relates to a method for oil mitigation in the cooling and lubrication of piston(s) for electronic fuel injected internal combustion engines, incorporating cylinder cutout technology. This concept leverages the engine fuel injection table and determines which cylinder(s) or bank of cylinders are to be cutout and specifically, reduces the pulse width of the fuel injected into those cylinder(s) to an idle condition, whereby reducing the reverse oiling and wet stacking effect, prevalent in traditional cylinder cutout technology.

### BACKGROUND

Mitigating reverse oil flow to the combustion chamber during cylinder cutout and cylinder deactivation has posed an arduous task for many diesel and gas engine builders, globally. A large percentage of compression-ignition and spark-ignition internal combustion engines utilize a many decades old technology, referred to as “Cylinder Cutout” (CCO). CCO is a term defining an operation of eliminating the contribution of multiple cylinders or individual cylinders to reduce fuel consumption during lighter payload conditions. A closely related category, termed, “Cylinder Deactivation” (CDA), additionally interrupts valve motion to the cutoff cylinder(s). The Sturtevant 38 was a 6-cylinder automobile, produced in Boston, Mass. in 1905 whereby, the driver could deactivate 3-cylinders by shutting off the magneto (spark) and opening the exhaust valves on the respective cylinders.

GM experienced a growing concern with their own version of CDA, termed “Active Fuel Management”, which they introduced in 2005 to the generation IV small-block gas engine. Designers learned that deactivating cylinders on long highway drives definitely reduced fuel consumption; however, these non-firing cylinders allowed oil to enter the combustion chamber, giving rise to high oil consumption. The inactive pistons still reciprocate in the cylinder bores and generate heat from frictional forces, wherein lubricating and cooling the pistons is still necessary. GM learned that over-lubricating during periods of deactivation, results in “cooking” the oil on a hot piston, creating a buildup of burnt oil deposits on the piston rings. This buildup of burnt deposits develops into a scenario of continuous oil consumption. GM introduced a shield to keep the oil from “slugging-up” the piston bore. Zheng Ma PhD, of General Motors addresses this issue of oil leakage in SAE Technical Paper 2010-01-1098, “Oil Transport Analysis of a Cylinder Deactivation Engine”. Ma suggests a redesign of the piston lands and drain holes and in particular, limits the oil supply to the bottom of the piston. In 2018, GM introduced a revamped version of their cylinder deactivation, termed “Dynamic Fuel Management”.

When cylinders are cutout and the valves remain “sealed”, these inactive cylinders continue to move up and down within the cylinder cavity, creating a vacuum, resulting in reverse oil flow to the combustion chamber and through the exhaust port. The historical term for cylinders being externally reciprocated up and down within the cylinder cavity during cylinder cutout operation, is “motoring”. Various versions of CDA currently being introduced to spark-ignited and compression-ignited engines incorporate a sequencing concept for manipulating the intake and exhaust valves. The motivation for this valve actuation is to create an increase in the cylinder pressure (mechanical spring effect), whereby reducing oil accumulation in the cylinder. CDA strategies rely on frequent cycles of entering and exiting this deactivated state of combustion, commonly expressed as “recharging” or “active regeneration”. Exiting deactivation at frequent intervals is crucial to keep unwanted oil from entering the cylinder and to maintain elevated cylinder temperatures. These strategies assist in reducing excessive oil from entering the cylinder and allow the burn-off of accumulated oil and particulate matter in the cylinder, prior to entering the after-treatment system.

An in-depth research study in Frontier Mechanical Engineering, 21 Aug. 2019, to Eaton Vehicle Group, Galesburg, Mich., USA and The Mechanical Engineering Department of Purdue University, West Lafayette, Ind., USA compares their experimental laboratory results of CCO and CDA technologies. Their definition is as follows: “Cylinder deactivation and cylinder cutout are different operating strategies for diesel engines. CDA includes the deactivation of both the valve motion and the fuel injection of select cylinders, while cylinder cutout incorporates only fuel injection deactivation in select cylinders”.

U.S. Pat. No. 11,421,565 B1 to Holihan et al. addresses a method to mitigate reverse oil flow to the combustion chamber in deactivated cylinders by incorporating a closed loop system that senses the fuel injection table shutoff state and restricts the delivery of lubrication and cooling oil accordingly. However, this strategy only includes engines incorporating CDA.

Caterpillar whitepaper LEXE0832-00, to Brian Jabeck, October 2014, entitled “The Impact of Generator Set Underloading” details another example of engines not incorporating the deactivating valve actuators. These diesel generator sets, normally operate at light load conditions for extended periods of time, whereby a condition, termed “wet stacking” or “exhaust manifold slobber” may result. Jabeck explains it as a “blackened, liquid substance squeezed out from the joints of the exhaust manifold or turbocharger and results in unburned fuel mixing with carbon particles and lubricating oil”. Caterpillar introduced a generator set, model Cat3500 to counter the effects of wet stacking and, specifically includes “Cold and Idle Cylinder Cutout”, optimized piston assembly designs and specialized exhaust seals.

Despite prior efforts, until the present invention, there appears to be no documented strategy to mitigate reverse oil flow to the combustion chamber, for the category of “Cylinder Cutout”, without executing continual intervals of “recharge”, or “active regeneration”, therefore the present disclosure addresses this ongoing challenge.

### SUMMARY

It is therefore an object of the present invention to provide a method to mitigate reverse oil flow to the combustion chamber for cylinder cutout without the necessity to terminate combustion and continually recharge the cylinder. The present invention disclosure generally relates to compression-ignited, spark-ignited, fuel-injected engines incorporating electronically controlled cylinder cutout architecture.

The present invention, using a hybrid cylinder cutout strategy (HCCO), referred to as “Smart Firepower”, leverages the modern fuel injection cutout strategy for determining the cylinder(s) or bank to be cutout. Upon determination, the HCCO module receives the cylinder cutout list from the ECM CCO module. These targeted cylinder(s) are set to an “idle-cylinder” state, whereby combustion in the cylinder becomes reduced but not terminated. The crankcase, pressure-fed, piston cooling and lubrication oil method or the use of piston cooling oil flow nozzles designed to direct oil to the piston underside(s), remains unchanged. A significant benefit of HCCO is the ability to maintain an elevated cylinder temperature unlike traditional CCO, by not requiring continual recharge. A higher cylinder temperature translates to a higher exhaust temperature, producing an improvement in after-treatment of particulate matter and engine efficiency. In addition, maintaining the hybrid cylinder in a minimal state of low combustion or idle, the intake and exhaust valves remain operational, preventing the reverse migration of oil from entering the combustion chamber.

An aspect of the present invention that is inherent in cylinder cutout is to compensate for the reduced power contributed by the idle-cylinders. By adjusting the fuel to the “working-cylinders”, the aggregate power of the system remains approximately consistent with the power generated prior to HCCO.

### BRIEF DESCRIPTION OF THE DRAWINGS

FIG. 1 depicts a schematic illustration embodying the present invention.

FIG. 2 is a flowchart illustrating the HCCO strategy for use with the present invention.

### DETAILED DESCRIPTION

The embodiment described in the present invention is by way of illustration only and should not be construed in any way, to limit the scope of the invention. Those skilled in the art will understand that the principles of the present invention may be implemented in any type of suitably arranged device or system. The drawings may not necessarily be to scale and certain features illustrated in a schematic form. As used in the specification and claims, for the purpose of describing and defining the disclosure, the term “substantially” and “moderately” represents the degree by which a quantitative representation may vary from a stated reference without resulting in a change in the basic function of the subject matter at issue. As used herein, the term module, or block, refers to an application specific integrated circuit (ASIC), a processor that is shared, dedicated, or part of a group and memory that executes firmware, software, combinational logic circuits that perform the functionality of this invention. OEM is a standard industry term that stands for original equipment manufacturer. ECM refers to an engine control module. HCCO protocol requires use on an engine initially designed with programmed cylinder cutout architecture.

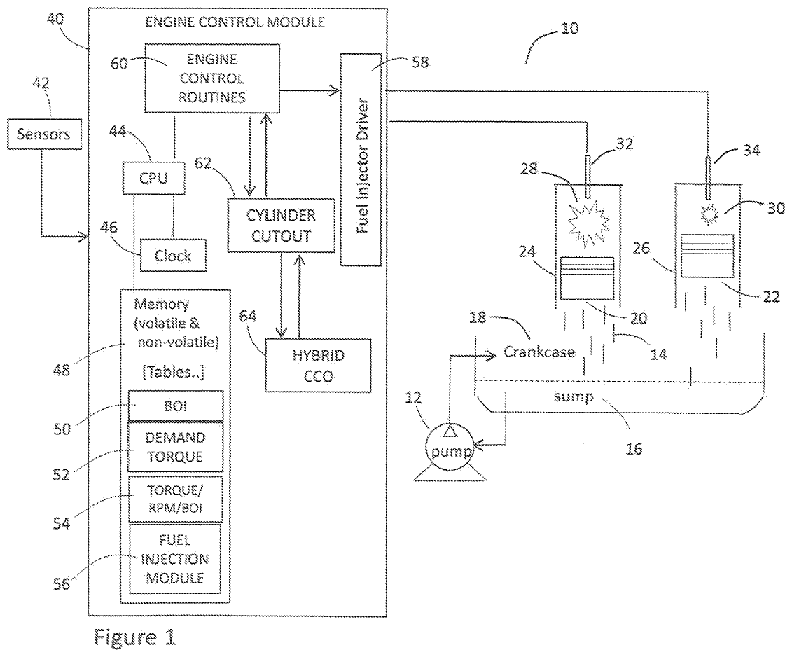

FIG. 1 includes a compression-ignition and/or a spark-ignition, 2-cylinder configuration engine 10 that comprises a typical oil lubricating, fixed or variable displacement pump 12, used to pressure-feed cooling oil 14 from the oil sump 16, through engine components (not illustrated) and within the crankcase 18 cavity to the piston undersides(s) 20, 22. Splashed and sprayed oil 14 is illustrated, dripping off the piston underside(s) 20, 22 to the oil sump 16. The pressure-fed oil is commonly routed through drilled crankshaft holes, directed, and splashed to the piston underside (not illustrated). Another method is to route the oil through a piston cooling flow nozzle assembly (not illustrated). Pistons move up and down within the cylinder(s) 24, 26, whereby fuel injected through fuel injector(s) 32, 34 into the combustion chamber(s) 28, 30, wherein chamber 28 illustrates substantial combustion activity, referred to as a “working-cylinder”. Combustion chamber 30, in contrast, exhibits minimal combustion activity, termed “idle-cylinder” in the present invention. A minimum quantity of injected fuel into the idle-cylinder shall prevent the piston from “motoring” in the cylinder cavity; therefore, never terminating combustion. As an analogy, an idle-cylinder may be thought of as a pilot light on an older gas furnace.

A conventional ECM 40, with attached engine sensors 42 comprises a CPU 44, System Clock 46, Memory 48(includes RAM, EEPROM, FLASH), memory look-up tables, including BOI 50, DEMAND TORQUE 52, TORQUE/RPM/BOI 54, FUEL INJECTION MODULE 56, Fuel Injector Driver 58 to fire fuel injector(s) 32, 34. ENGINE CONTROL ROUTINES 60, wherein CCO block 62 makes a determination (as an example) of whether a single cylinder or bank of cylinders is to transition to a cutout state and communicates to HCCO block 64 of the present invention. HCCO module 64 sets cylinder 26 to an idle or “no-load” state. An idle fuel state precludes the cylinder from cooling off on long distance vehicle trips and losing its ability to burn off accumulated particulate matter, as defined by “wet-stacking”. HCCO block 64 is additionally responsible for returning the idle-cylinder to a working-cylinder state 28 upon determination by CCO module 62, to transition to all working-cylinder(s). A requirement for the idle-cylinder 26 to transition back to a working cylinder 24 is to operate above an idle speed.

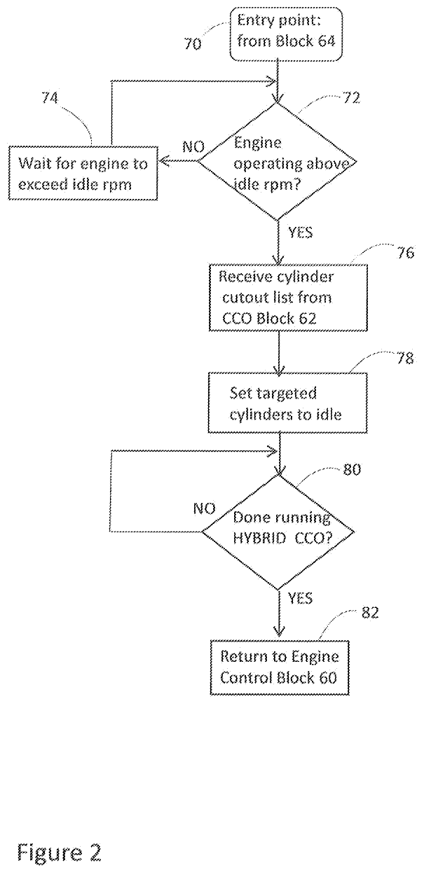

Turning to FIG. 2, block 70 defines the entry point for the software control routine illustrated in FIG. 1, HCCO module 64. An initial condition for HCCO module 64 is determined at decision block 72. If the engine is operating at an above idle rpm, the “YES” path shall be taken to block 76; however, if the engine is not above idle, the “NO” path shall be taken to block 74. Block 74 is responsible for raising the engine rpm moderately above an idle condition. CCO and HCCO methodologies recover the power lost in the cutout cylinder(s) with added fuel injected to the remaining working cylinders and commonly referred to as “pumping loss”.

Block 76 reads a list of cylinders to be cutout, as illustrated in CCO module 62 of FIG. 1. CCO module 62 may execute the cutout of one cylinder or a plurality of cylinders, whereby an entire “left bank” or “right bank” may be cutout. The OEM engine architecture and CCO methodology dictates the how and the number of cylinders to be cutout.

Block 78 receives the cutout list of cylinders and performs a HCCO, whereby each targeted cylinder is lowered to an idle rpm and specifically, the said cylinder is not totally cutout. Each hybrid cylinder will have minimal combustion as illustrated by combustion chamber 30 from FIG. 1. An idle condition will maintain combustion and not require the cylinder to be in continual intervals of cutout and recharge.

Decision Block 80 receives an instruction whether to continue operating the engine in a HCCO mode, or not. If “YES”, the path to Decision Block 82 is taken, whereas if “NO”, a loop-back to continue HYBRID CCO is taken.

Return Block 82 directs the flow of program control back to Block 60 of FIG. 1, whereby normal engine operation is dictated by the vehicle operator engine control.

What is claimed is:

1. A method of mitigating lubricating oil from entering the combustion chamber, in a fuel-injected, spark-ignited, compression-ignited, internal combustion engine, having at least two cylinders comprising cylinder cutout, the method comprising the steps of:
sensing an operator demand requesting the engine be placed in cylinder cutout; and
monitoring engine speed while waiting for the engine to exceed an idle speed; and
communicating a list of cylinders targeted to be cutout, to a routine that sets the said cylinder(s) to an idle state, whereby said idle state keeps the said cylinder(s) warm, without terminating combustion; and
waiting in a loop during the idle state until the operator requests normal engine operation, whereby allowing traditional valve operation, helping prevent reverse oil flow to the combustion chamber.

2. A method according to claim 1 wherein the engine is using a crankcase pressure-fed, oil spray and splash, piston cooling and lubricating system.

3. A method according to claim 1 wherein the engine is using an oil flow nozzle, piston cooling and lubricating system.

4. A method according to claim 1 wherein the engine powers a commercial vehicle.

5. A method according to claim 1 wherein the engine powers an off-highway vehicle.

6. A method according to claim 1 wherein the engine powers a railway locomotive.

7. A method according to claim 1 wherein the engine powers a military vehicle.

8. A method according to claim 1 wherein the engine powers a marine vehicle.

9. A method according to claim 1 wherein the engine powers an automotive vehicle.

10. A method according to claim 1 wherein the engine powers a generator set.
